(19) United States
(12) Patent Application Publication
(10) Pub. No.: US 2021/0060474 A1
(43) Pub. Date: Mar. 4, 2021

(54) METHOD FOR PREDICTING THE SERVICE LIFE OF A FILTER

(71) Applicant: Carl Freudenberg KG, Weinheim (DE)

(72) Inventors: Thomas Caesar, Weinheim (DE); Thomas Schroth, Bobenheim-Roxheim (DE); Karsten Schulz, Neckarbischofsheim (DE); Sandra Sell-Poelloth, Maikammer (DE); Renate Tapper, Bensheim (DE); Patrick Weber, Weinheim (DE)

(21) Appl. No.: 17/005,344

(22) Filed: Aug. 28, 2020

(30) Foreign Application Priority Data
Aug. 29, 2019 (EP) 19 194 387.7

(51) Int. Cl. B01D 46/00; B01D 46/42; F01D 21/00

(52) U.S. Cl. CPC B01D 46/0086; B01D 46/429; F01D 21/003; F05D 2270/313; B01D 2279/60; F05D 2260/80; F05D 2260/81; B01D 2273/18

(57) ABSTRACT

A method for predicting a service life of a filter element of a filter module in a system, the filter element serving to clean air, includes the steps of: a) retrieving characterization data of the system from a database; b) retrieving characterization data of the filter element from a database; c) retrieving measurement data of the system detected in the system by sensor technology; d) retrieving measurement data of the filter element detected by the sensor technology in the filter module; e) retrieving measurement data of air to be cleaned; and f) creating a data model from the data and determining the service life of the filter element to be expected.

### CROSS-REFERENCE TO PRIOR APPLICATION

Priority is claimed to European Patent Application No. EP 19 194 387.7, filed on Aug. 29, 2019, the entire disclosure of which is hereby incorporated by reference herein.

### FIELD

The invention relates to a method for predicting the service life of a filter, to a computer program for carrying out the method, and to a system for predicting the service life.

### BACKGROUND

It is known from prior art that a wide variety of systems in which processes take place have a certain need for air. For example, power generation plants may have a certain need for process air. This need usually comprises a certain amount of air and a certain air quality. This is why filter modules with filter elements are used. The filter elements can be designed, for example, as surface filters, high-temperature filters or pocket filters. A filter module frequently comprises a plurality of filter stages, i.e. filter elements arranged, for example, in series.

Filter elements are generally exchanged when the filtration performance no longer meets the requirements, i.e. when the process air can no longer be provided in sufficient quality. Alternatively, filters are exchanged prophylactically to ensure that the filtration performance continues to be met. Filtration performance in this connection does not necessarily mean insufficient cleaning of the air, but it can also mean that, for example, a fan in a system can no longer convey sufficient air due to the increase in pressure or that the efficiency of a turbine in a system becomes worse and the system therefore becomes uneconomical. In either case, exchanging the filter elements causes a shutdown and downtime of the system, which has a negative effect on the overall performance of the system. The shutdown and subsequent startup of the system requires additional energy, which likewise has a disadvantageous effect on the currently provided performance of the system. If the service life of a filter can be better exploited and a required filter change can be better planned in terms of time, the filter change can be scheduled for a time when the system is down for other reasons or is scheduled to run at least only at reduced performance.

### SUMMARY

In an embodiment, the present invention provides a method for predicting a service life of a filter element of a filter module in a system, the filter element serving to clean air, the method comprising the steps of: a) retrieving characterization data of the system from a database; b) retrieving characterization data of the filter element from a database; c) retrieving measurement data of the system detected in the system by sensor technology; d) retrieving measurement data of the filter element detected by the sensor technology in the filter module; e) retrieving measurement data of air to be cleaned; and f) creating a data model from the data and determining the service life of the filter element to be expected.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a system for predicting the service life of a filter, and

FIG. 2 shows a flowchart of a method for predicting the service life of a filter.

### DETAILED DESCRIPTION

In an embodiment, the present invention enables a better prediction of the service life of a filter, in order to be able to better plan maintenance work for replacing filters. In an embodiment, the present invention increases the overall performance of the system.

In an embodiment, the present invention provides a method for predicting the service life of a filter having the features described herein.

According to the invention, it was found to be advantageous to use data of the filter module, the system and the air to predict the service life.

The computer-implemented method according to the invention serves for predicting the service life of a filter element of a filter module in a system, in particular a power generating plant, wherein the filter element serving for purifying air comprises the steps of:
a) retrieving characterization data of the system from a database;
b) retrieving characterization data of the filter element from a database;
c) retrieving measurement data of the system detected in the system by means of sensor technology;
d) retrieving measurement data of the filter element detected in the filter module by means of sensor technology;
e) retrieving measurement data of the air to be cleaned;
f) creating a data model from the aforementioned and previously retrieved data and determining, i.e. calculating the service life of the filter element to be expected, in each case in a processing unit. The creation of the data model and determination of the service life takes place using a software executed on the processing unit with algorithms and calculation rules stored in said software.

Thanks to the determination of a prediction of the service life of a respective filter element, the filter element can be used longer and no longer needs to be changed prophylactically. Resources can thereby be advantageously saved.

This also allows for moving maintenance work on the filter element to already planned downtimes that are as close as possible to the maximum service life of the filter element. System downtimes can thus be reduced and limited, which results in a higher overall performance of the system.

A prediction of the service life of a respective filter element can be determined continuously such as to always calculate a current prediction value. Alternatively, the data can also be collected and a prediction of the service life of a respective filter element can take place at regular time intervals, for example on a daily basis.

In further embodiment of the method, the retrieval of the data is carried out by a remote server using a data transmission connection, that is to say a communication connection (for example wired, via radio, via the Internet, by means of IoT integration of the components). Remote server means that this server is not set up directly at the site of the system. In other words: the system, used databases and the processing unit can be located at different sites. The processing unit may be part of the remote server.

In a particularly advantageous and therefore preferred further embodiment of the method, the step of “retrieving measurement data of the system” also comprises retrieving prediction data of the system from the system control.

It has been found to be advantageous if the step of “retrieving measurement data of the air to be cleaned” also comprises retrieving prediction data of the air to be cleaned from meteorology databases linked by data transmission technology.

In a particularly advantageous and therefore preferred further embodiment of the method, empirical values of comparable filter elements and/or comparable systems can be included in the step of “creating a data model and determining the service life”.

The method could comprise an additional step of:

Outputting the service life of the filter element to be expected via an interface to a user or to the system control and/or outputting an order request of a filter element to be exchanged to an online shop. This enables a predictive maintenance of the filter module.

The more comprehensive the data base that is included in the data model for determining the service life, the more the accuracy of the prediction is increased.

The following data has been identified as particularly meaningful and relevant, which is why its—individual or cumulative—consideration appears to be advantageous:

as characterization data of the system, the type (in particular the type of air supply, such as supply air, exhaust air, circulating air, variability), the structure (in particular the set-up of a plurality of filter modules in a plurality of filter stages, the presence of weather protection devices, humidifiers or dehumidifiers, heat exchangers and fans

as characterization data of the filter element, the filter equipment (e.g. existing particulate and gas filter layers) and filter characteristics (such as the initial pressure difference, the pressure difference profile and fraction separation rates for PM10, PM2.5, PM1 or total)

as measurement data of the system, the operating times and/or the air requirement (in particular by indicating the volume flow rate) and possibly of temperature, humidity or vibrations in the system

as measurement data of the filter element, the filter state (e.g. the current pressure difference, loading or microbial load), wherein the sensor technology for this may comprise, for example, pressure difference sensors or optical sensors

as measurement data of the air to be cleaned, its temperature, its humidity, its particle load, the concentration of gases and/or the expression of wind (incl. the wind direction and the wind strength), wherein the sensor technology may comprise, for example, humidity and temperature sensors or air speed meters (anemometers) and wind energy directors.

as prediction data of the system, planned operating times and/or the system performance planning and the resulting air requirements

as prediction data of the air to be cleaned, weather forecast data, pollen count prediction data and/or seasonal and local empirical values (e.g. particulate pollution on New Year's Eve and New Year's Day in wide parts of Germany)

The invention also relates to a computer program with program code means to execute all method steps of the method described above when the computer program is executed on a processing unit.

The invention also relates to a system for predicting the service life of a filter element of a filter module, for carrying out the method steps according to the above-described method, and comprises the following components:
a system having a filter module with at least one filter element for cleaning air,
at least one database where characterization data of the system and characterization data of the filter element are stored,
at least one sensor for detecting measurement data of the system
at least one sensor for detecting measurement data of the air S4 and
at least one sensor for detecting measurement data of the filter element,
a server having a processing unit for retrieving the measurement data and creating a data model from the data and determining the service life of the filter element to be expected
possibly an output unit for outputting the service life of the filter element to be expected.

The at least one sensor for detecting measurement data of the system can be positioned in the system. The at least one sensor for detecting measurement data of the filter element can be positioned in the filter module. Alternatively, however, it is also possible for a sensor to provide measurement data used both for detecting measurement data of the filter element and for detecting measurement data of the system. Thus, the functionality of a sensor is decisive rather than its local positioning. What is also conceivable, for example, is a pressure difference measured at the filter module to determine the operating time of the system. To increase the accuracy of the determination of the filter element's service life to be expected, a plurality of sensors can also be used in each case.

In this application, a sensor is understood to mean the measuring unit for determining a measurement. Thus, for example a weather station having 6 sensors can detect 6 different measurements. According to this understanding, the sensor comprises not only the unit in which a physical or chemical effect is detected (sensor), but it also comprises the processing unit, which converts this measured effect into a further processable electrical signal.

Advantageous further embodiments of the system result from the above description of the method and from its possible embodiments.

The described invention and the described advantageous further embodiments of the invention constitute advantageous further embodiments of the invention also in combination with one another insofar as this is technically reasonable.

With respect to further advantages and embodiments of the invention that are advantageous from a design and functional standpoint, reference is made to the sub-claims and the description of exemplary embodiments, with reference to the accompanying figures.

The invention will now be explained in more detail using the accompanying figures. Corresponding elements are provided with the same reference symbols in the figures. For the sake of better clarity of the figures, a presentation that is true to scale has been dispensed with.

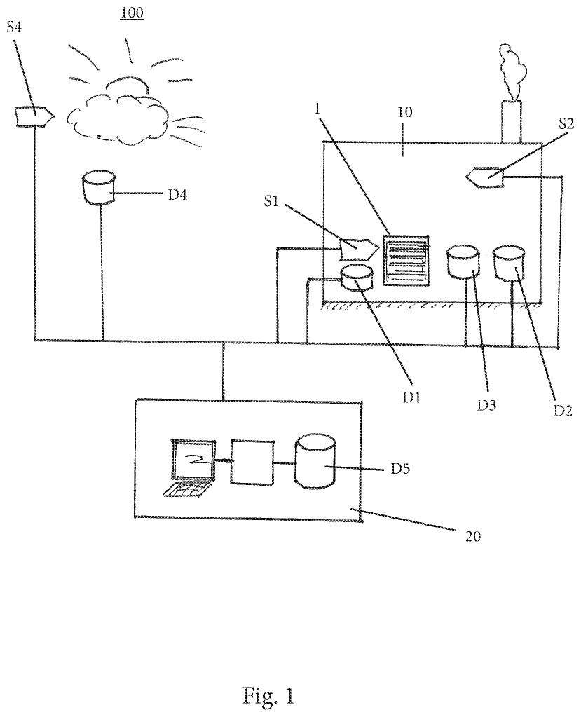

FIG. 1 shows a system for predicting the service life of a filter element of a filter module 1 in a system 10.

The system comprises the following components:
a system 10 with a filter module 1 with at least one filter element for cleaning air,
a database in which characterization data of the system D2 and characterization data of the filter element D1 are stored,
at least one sensor in the system for detecting measurement data of the system S2
at least one sensor for detecting measurement data of the air (S4) and
at least one sensor in the filter module for detecting measurement data of the filter element S1,
a server 20 for retrieving the measurement data and creating a data model from the data and determining, namely calculating, the service life of the filter element to be expected. During determination, the server 20 can also resort to a data model of empirical values D5 of comparable filters and systems.

In addition to measurement data and characterization data, prediction data of the system D3 and prediction data of the air D4 can also be included in the data model.

The various databases and the server 20 may each be located at different locations or at the same location. It is only important that the server 20 has access to all required databases.

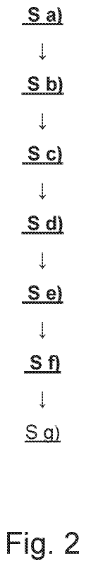

The method shown in the flowchart of FIG. 2 is used to predict the service life of a filter element of a filter module 1 in a system 10, wherein the filter element serving to clean air comprises the steps of:
S a) retrieving characterization data D2 of the system 10 from a database
S b) retrieving characterization data of the filter element D1 from a database
S c) retrieving measurement data of the system S2 detected by means of sensor technology in the system and possibly of prediction data of the system D3
S d) retrieving measurement data of the filter element S1 detected by means of sensor technology in the filter module
S e) retrieving measurement data of the air S4 to be cleaned and possibly of prediction data of the air to be cleaned D4
S f) creating a data model from the aforementioned data and determining, i.e. calculating, the service life of the filter element to be expected.

The method could comprise an additional step S g):
Outputting the service life of the filter element to be expected via an interface to a user or to the system control and/or outputting an order request of a filter element to be exchanged to an online shop.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Filter module with filter elements

### 10 System

20 Server with processing unit and output unit

### 100 Environment

D1 Filter module characterization data
D2 System characterization data
D3 System prediction data
D4 Air prediction data
D5 Data model from empirical values
S1 Filter module measurement data
S2 System measurement data
S4 Air measurement data

What is claimed is:

1. A method for predicting a service life of a filter element of a filter module in a system, the filter element serving to clean air, the method comprising the steps of:
a) retrieving characterization data of the system from a database;
b) retrieving characterization data of the filter element from a database;
c) retrieving measurement data of the system detected in the system by sensor technology;
d) retrieving measurement data of the filter element detected by the sensor technology in the filter module;
e) retrieving measurement data of air to be cleaned; and
f) creating a data model from the data and determining the service life of the filter element to be expected.

2. The method according to claim 1, wherein retrieving the data is performed by a remote server using a data transmission connection.

3. The method according to claim 1, wherein in step c) prediction data of the system is additionally retrieved from the system control.

4. The method according to claim 1, wherein in step e) prediction data of the air to be cleaned is additionally retrieved from meteorology databases.

5. The method according to claim 1, wherein in step f) empirical values of comparable filter elements and/or systems are used.

6. The method according to claim 1, further comprising an additional step of:
g) outputting the service life of the filter element to be expected via an interface to a user or to a control of the system and/or outputting an order request of a filter element to be exchanged to an online shop.

7. The method according to claim 1, wherein the characterization data of the system comprises a type, a structure, and/or a position of the system.

8. The method according to claim 1, wherein the characterization data of the filter element comprises the filter equipment and filter characteristics.

9. The method according to claim 1, wherein the measurement data of the system comprises operating times and/or an air requirement.

10. The method according to claim 1, wherein the measurement data of the filter element comprises a filter state.

11. The method according to claim 1, wherein the measurement data of the air to be cleaned comprises a temperature, a humidity, a particle load, a concentration of gases, and/or an expression of wind.

12. The method according to claim 3, wherein the prediction data of the system comprises planned operating times and/or planned air requirements.

13. The method according to claim 4, wherein the prediction data of the air to be cleaned comprises weather forecast data, pollen count prediction data, and/or seasonal empirical values.

14. A computer program with program code for performing the method according to claim 1 when the computer program is executed on a processing unit.

15. A system for predicting a service life of a filter element of a filter module, for carrying out the method steps according to claim 1, comprising:
a system having at least one filter module with at least one filter element for cleaning air;
a database in which characterization data of the system and characterization data of the filter element are stored;
at least one sensor configured to detect measurement data of the system;
at least one sensor configured to detect measurement data of the air;
at least one sensor configured to detect measurement data of the filter element; and
a server with a processing unit configured to retrieve the measurement data, create a data model from the data, and determine the service life of the filter element to be expected.
